(19) United States
(12) Patent Application Publication
(10) Pub. No.: US 2015/0085789 A1
(43) Pub. Date: Mar. 26, 2015

(54) TIME COORDINATION TO IMPROVE THROUGHPUT FOR D2D BROADCAST

(71) Applicant: QUALCOMM Incorporated, San Diego, CA (US)

(72) Inventors: Shreeshankar Ravishankar BODAS, Belle Mead, NJ (US); Saurabha Rangrao TAVILDAR, Jersey City, NJ (US); Beibei WANG, Bridgewater, NJ (US); Qiao LI, Hillsborough, NJ (US); Bilal SADIQ, Basking Ridge, NJ (US)

(21) Appl. No.: 14/461,324

(22) Filed: Aug. 15, 2014

Related U.S. Application Data
(60) Provisional application No. 61/882,375, filed on Sep. 25, 2013.

(51) Int. Cl. H04W 72/10; H04L 5/00

(52) U.S. Cl. CPC H04W 72/10; H04L 5/0058
USPC 370/329

(57) ABSTRACT

A method, an apparatus, and a computer program product for wireless communication are provided. The apparatus selects a subchannel for transmitting a signal, determines a priority of the selected subchannel with respect to one or more other subchannels respectively selected by one or more neighboring transmitters, determines whether to transmit the signal on the selected subchannel based on the priority.

### CROSS-REFERENCE TO RELATED APPLICATION(S)

This application claims the benefit of U.S. Provisional Application Ser. No. 61/882,375, entitled “TIME COORDINATION TO IMPROVE THROUGHPUT FOR D2D BROADCAST” and filed on Sep. 25, 2013, which is expressly incorporated by reference herein in its entirety.

### BACKGROUND

1. Field

The present disclosure relates generally to communication systems, and more particularly, to determining whether to transmit a signal on a selected subchannel based on a priority of the selected subchannel with respect to one or more other subchannels respectively selected by one or more neighboring transmitters.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus selects a subchannel for transmitting a signal, determines a priority of the selected subchannel with respect to one or more other subchannels respectively selected by one or more neighboring transmitters; and determines whether to transmit the signal on the selected subchannel based on the priority.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram of a device-to-device communications system.

FIG. 8 is a diagram illustrating a rate cumulative distribution function (CDF) for receivers.

FIG. 9 is a flow chart of a method of wireless communication.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

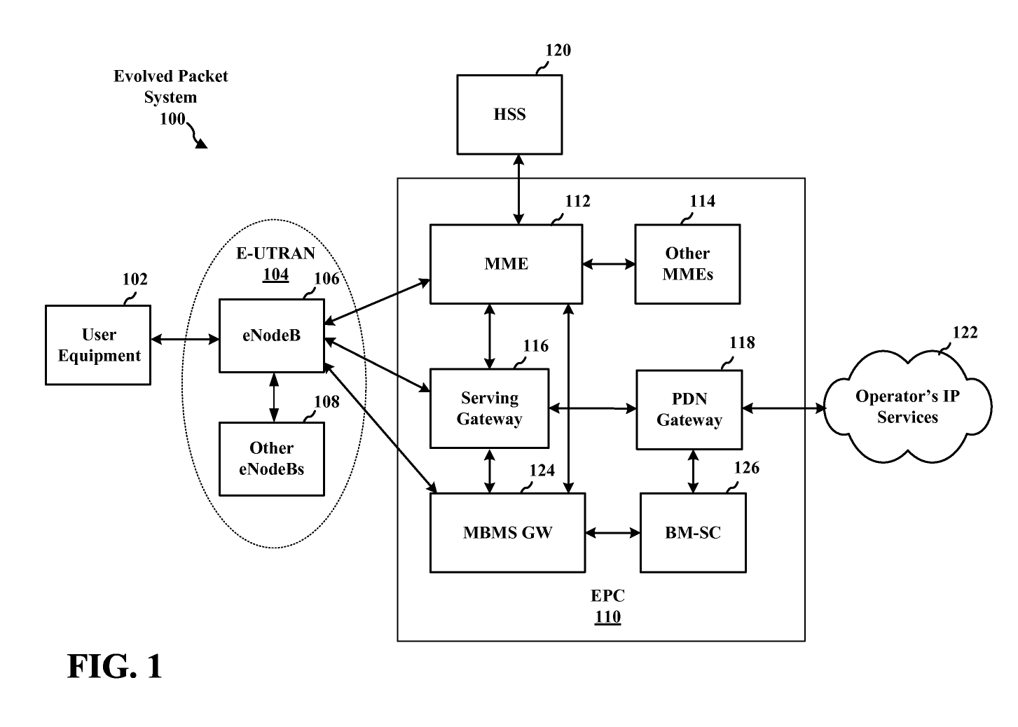

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

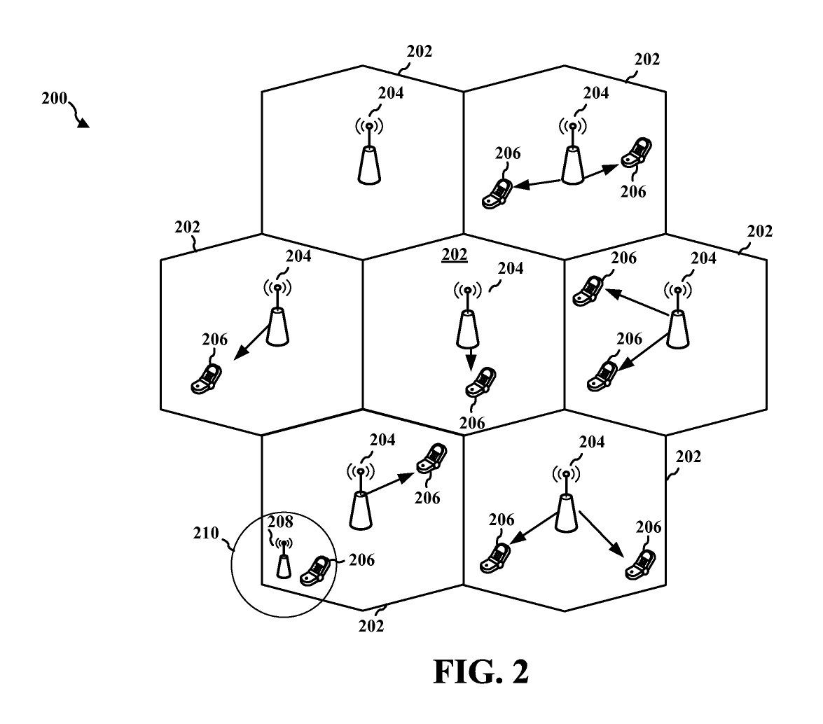

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

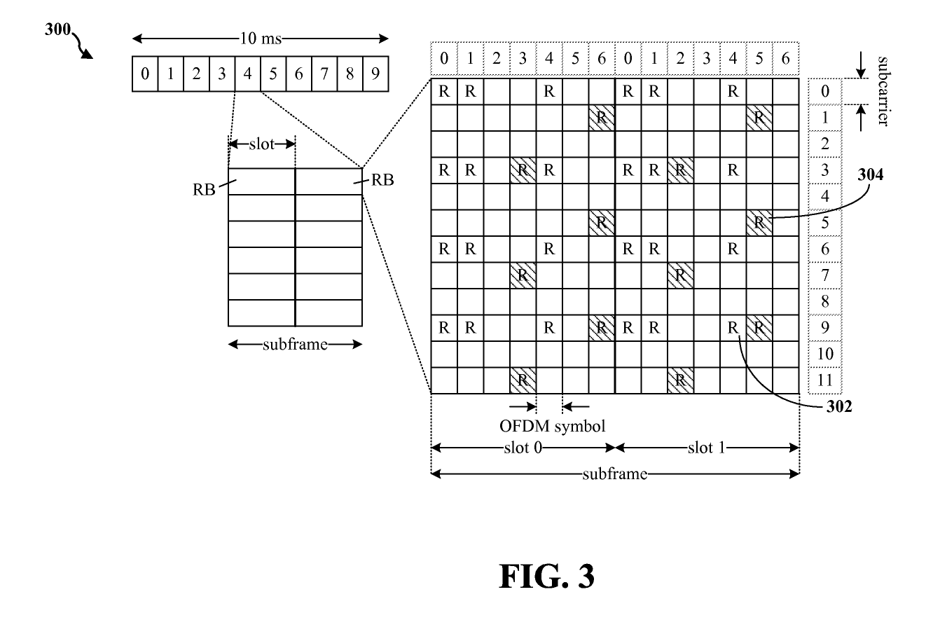

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

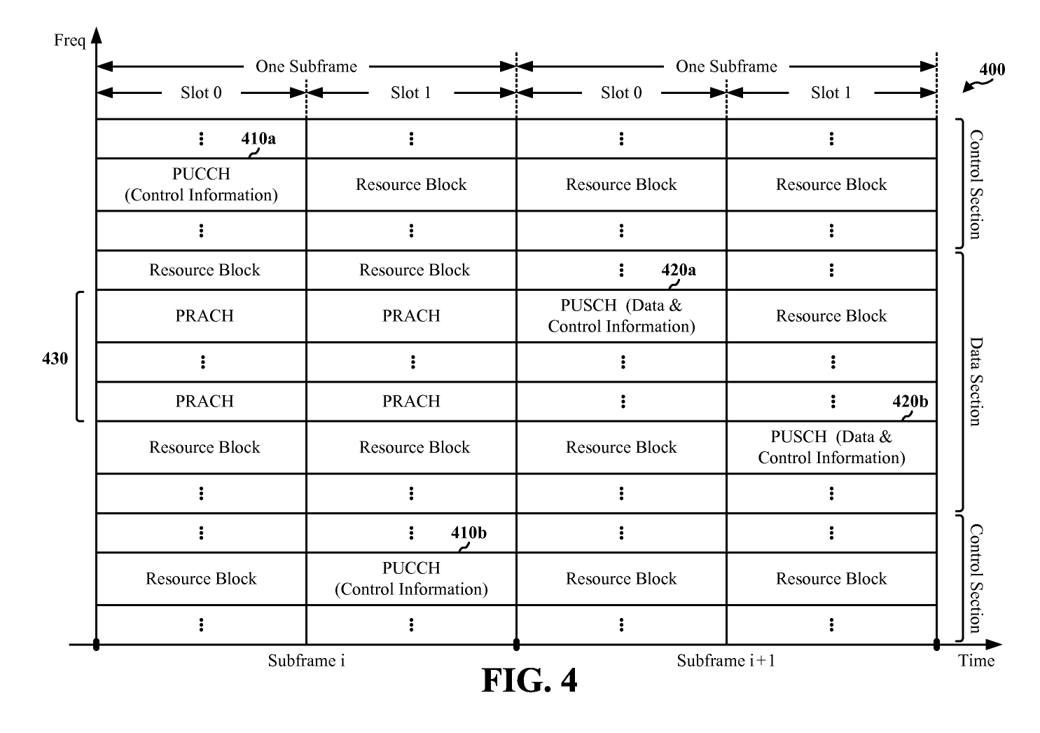

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

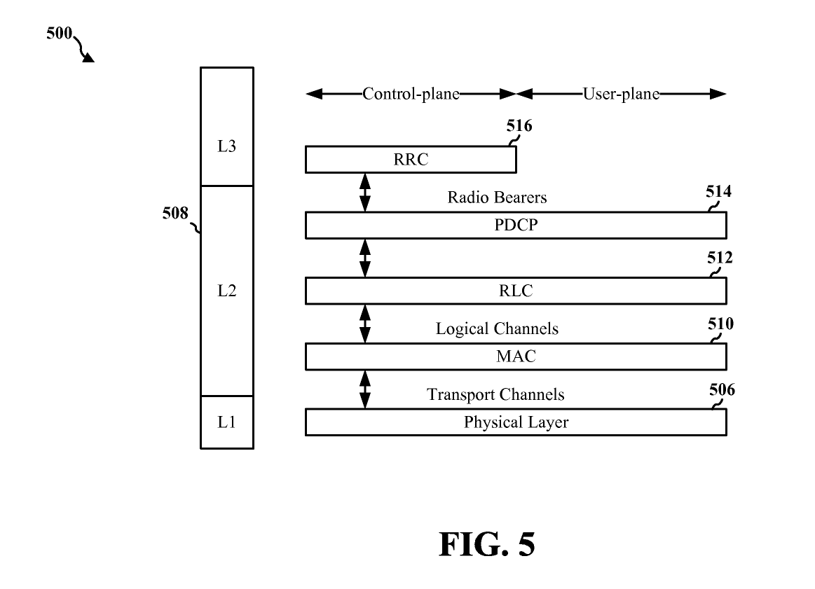

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

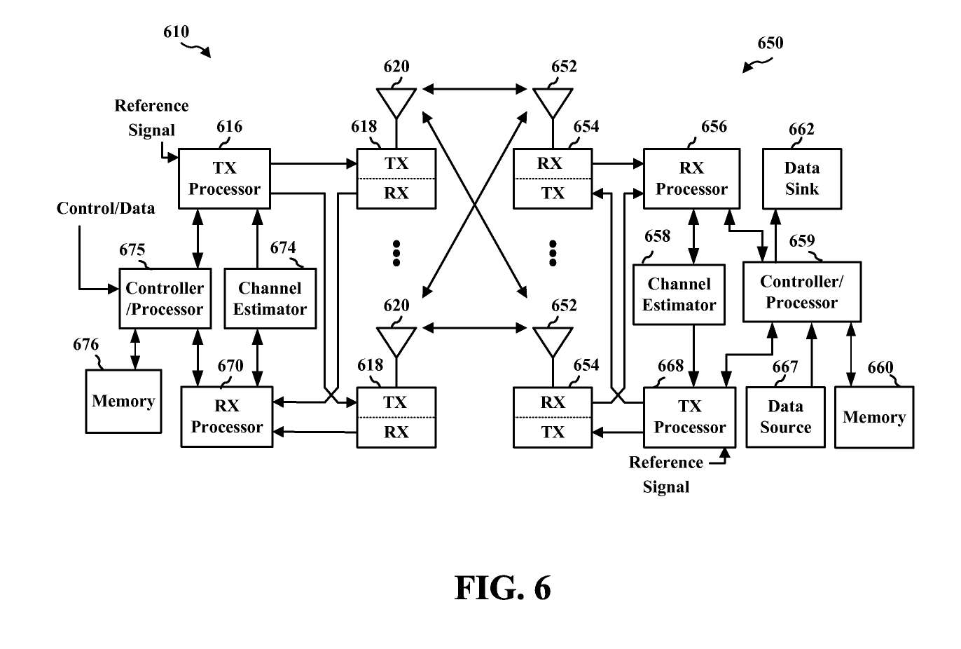

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

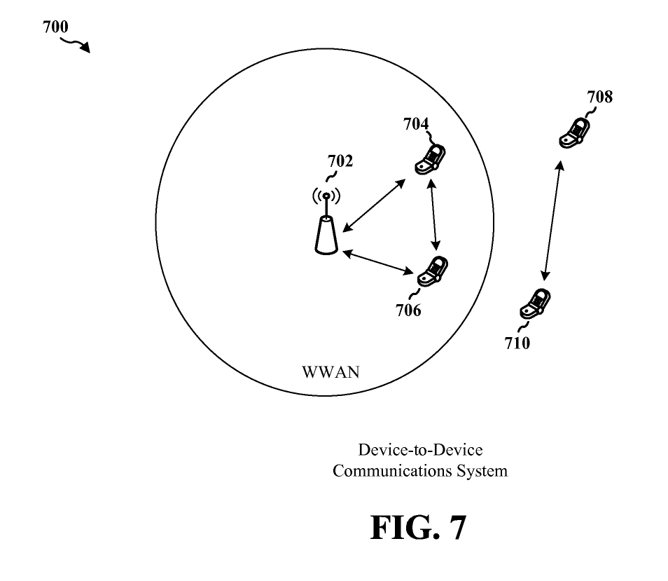

FIG. 7 is a diagram of a device-to-device (D2D) communications system 700. The device-to-device communications system 700 includes a plurality of wireless devices 704, 706, 708, 710. The device-to-device communications system 700 may overlap with a cellular communications system, such as for example, a wireless wide area network (WWAN). Some of the wireless devices 704, 706, 708, 710 may communicate together in device-to-device communication using the DL/UL WWAN spectrum, some may communicate with the base station 702, and some may do both. For example, as shown in FIG. 7, the wireless devices 708, 710 are in device-to-device communication and the wireless devices 704, 706 are in device-to-device communication. The wireless devices 704, 706 are also communicating with the base station 702.

The exemplary methods and apparatuses discussed infra are applicable to any of a variety of wireless device-to-device communications systems, such as for example, a wireless device-to-device communication system based on FlashLinQ, WiMedia, Bluetooth, ZigBee, or Wi-Fi based on the IEEE 802.11 standard. To simplify the discussion, the exemplary methods and apparatus are discussed within the context of LTE. However, one of ordinary skill in the art would understand that the exemplary methods and apparatuses are applicable more generally to a variety of other wireless device-to-device communication systems.

An aspect of the present disclosure is related to broadcast D2D communication motivated by public safety concerns. A baseline design for broadcast communication may be to divide a bandwidth into narrowband subchannels, wherein each transmitter of a number of neighboring transmitters may select one subchannel to transmit a signal. Subchannel selection may be based on received energy measurements.

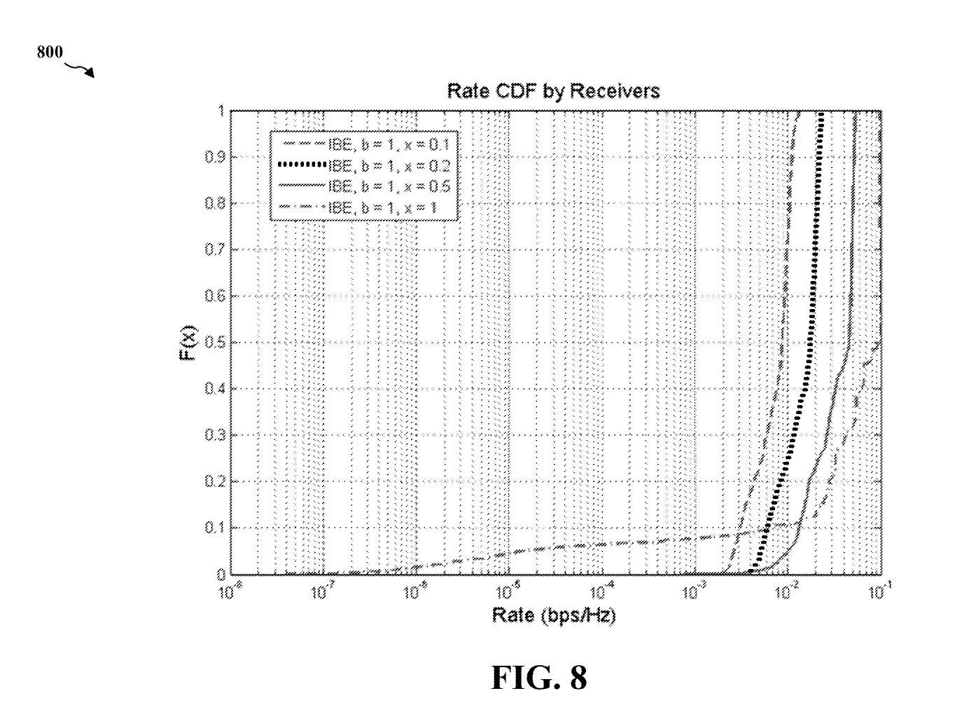

A limit on performance may be imposed by in-band emissions. An in-band emission (IBE) is interference caused by one transmitter transmitting on one subchannel and imposed on another transmitter transmitting to a receiver on another subchannel. In order to mitigate the interference due to IBE, the transmitters may orthogonalize their transmissions in time. This leads to improved performance due to a reduction in interference. An example of the effect of IBE on performance is illustrated in FIG. 8.

FIG. 8 is a diagram 800 illustrating a rate cumulative distribution function (CDF) for receivers. In FIG. 8, x represents a fraction of time a transmitter is on. Each transmitter transmits with a probability x independent of other transmitters. Here, x=1 shows significant outage due to high interference.

In the present disclosure, methods and apparatuses are provided to improve performance by facilitating coordination between transmitters. The present disclosure may assume a synchronous system.

In an aspect, each transmitter of a number of neighboring transmitters selects a narrowband subchannel and is aware of a subchannel selection of neighboring transmitters. An exemplary baseline solution may be as follows: For a given subframe, a transmitter may perform a random permutation of subchannels to define an order of priority among the transmitter's selected subchannel and the subchannels selected by the neighboring transmitters. The transmitter may then broadcast a signal if the transmitter's subchannel priority is a highest priority amongst all the subchannel priorities of the neighboring transmitters.

The baseline solution described above limits interference but only allows one transmitter of the number of neighboring transmitters to transmit during the given subframe. This limits performance. Hence, the present disclosure further provides a modification to the baseline solution to improve performance. For example, a transmitter may transmit a signal on a selected subchannel if the priority of the selected subchannel is amongst a top number of priorities (top %) amongst all the subchannel priorities of the neighboring transmitters. Additionally or alternatively, the transmitter may yield to transmitters that are beyond a certain pathloss threshold. This may be based on the phenomenon that two transmitters located far away from each other may cause significant interference to each other due to in-band emissions. If two transmitters are in close proximity to each other and use different subchannels for transmission, then the two transmitters virtually cause no interference to each other since the in-band emissions may be typically 30 dB below an occupied power.

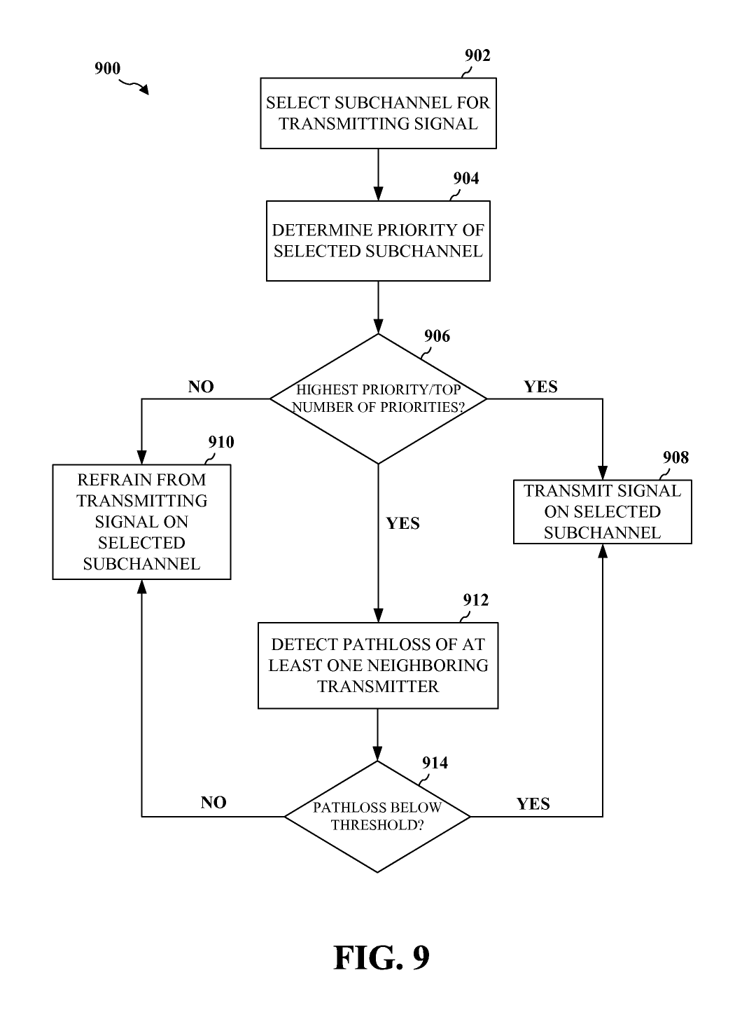

FIG. 9 is a flow chart 900 of a method of wireless communication. The method may be performed by a UE (e.g., any one of wireless devices 704, 706, 708, 710 in FIG. 7). At step 902, the UE selects a subchannel for transmitting a signal.

At step 904, the UE determines a priority of the selected subchannel with respect to one or more other subchannels respectively selected by one or more neighboring transmitters. The priority of the selected subchannel may be determined by first performing a random permutation for the selected subchannel and the one or more other selected subchannels. Thereafter, the UE may define an order of priority among the selected subchannel and the one or more other selected subchannels based on the random permutation.

Subsequent to step 904, the UE may determine whether to transmit the signal on the selected subchannel based on the priority. The transmission determination may include at step 906, the UE determining whether the priority of the selected subchannel is a highest priority, or one of a top number of priorities, among respective priorities of the one or more other selected subchannels. At step 908, the UE may transmit the signal on the selected subchannel when the priority of the selected subchannel is the highest priority among the respective priorities of the one or more other selected subchannels. Alternatively, at step 908, the UE may transmit the signal on the selected subchannel when the priority of the selected subchannel is one of the top number of priorities among the respective priorities of the one or more other selected sub channels.

At step 910, when the priority of the selected subchannel is not the highest priority among the respective priorities of the one or more other selected subchannels, the UE refrains from transmitting the signal on the selected subchannel. Alternatively, at step 910, when the priority of the selected subchannel is not one of the top number of priorities among the respective priorities of the one or more other selected subchannels, the UE refrains from transmitting the signal on the selected subchannel.

In an aspect, the UE may consider yielding to neighboring transmitters that are beyond a certain pathloss threshold when determining whether to transmit the signal on the selected subchannel. As described above, two transmitters located far away from each other may cause significant interference to each other due to in-band emissions. Therefore, the UE may decide to yield to another transmitter to avoid encountering interference when transmitting.

For example, after the UE determines at step 906 that the priority of the selected subchannel is the highest priority, or one of the top number of priorities, among the respective priorities of the one or more other selected subchannels, the UE at step 912 may further detect a pathloss of at least one neighboring transmitter. At step 914, the UE determines whether the detected pathloss is below a threshold. When the detected pathloss of the at least one neighboring transmitter is above the threshold, the UE proceeds to step 910 and refrains from transmitting the signal on the selected subchannel. When the detected pathloss of the at least one neighboring transmitter is below the threshold, the UE proceeds to step 908 and transmits the signal on the selected subchannel.

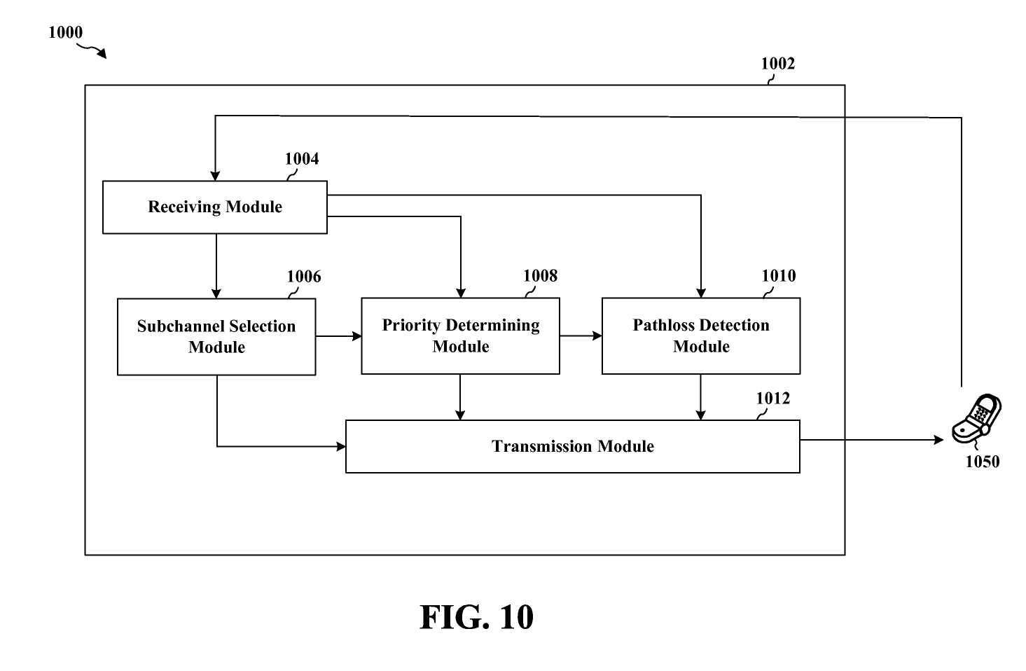

FIG. 10 is a conceptual data flow diagram 1000 illustrating the data flow between different modules/means/components in an exemplary apparatus 1002. The apparatus may be a UE (e.g., any one of wireless devices 704, 706, 708, 710 in FIG. 7). The apparatus includes a receiving module 1004, a subchannel selection module 1006, a priority determining module 1008, a pathloss detection module 1010, and a transmission module 1012.

The subchannel selection module 1006 selects a subchannel for transmitting a signal. The selected subchannel may be one of a number of narrowband subchannels of a divided bandwidth. Subchannel selection may be based on energy measurements received via the receiving module 1004.

The priority determining module 1008 determines a priority of the selected subchannel with respect to one or more other subchannels respectively selected by one or more neighboring transmitters 1050. The priority of the selected subchannel may be determined by first performing a random permutation for the selected subchannel and the one or more other selected subchannels. Thereafter, the priority determining module 1008 may define an order of priority among the selected subchannel and the one or more other selected subchannels based on the random permutation.

The priority determining module 1008 may determine whether to transmit the signal (via the transmission module 1012) on the selected subchannel based on the priority. The transmission determination may include the priority determining module 1008 determining whether the priority of the selected subchannel is a highest priority, or one of a top number of priorities, among respective priorities of the one or more other selected subchannels. The priority determining module 1008 may transmit the signal (via the transmission module 1012) on the selected subchannel when the priority of the selected subchannel is the highest priority among the respective priorities of the one or more other selected subchannels. Alternatively, the priority determining module 1008 may transmit the signal (via the transmission module 1012) on the selected subchannel when the priority of the selected subchannel is one of the top number of priorities among the respective priorities of the one or more other selected subchannels.

When the priority of the selected subchannel is not the highest priority among the respective priorities of the one or more other selected subchannels, the priority determining module 1008 refrains from transmitting the signal on the selected subchannel. Alternatively, when the priority of the selected subchannel is not one of the top number of priorities among the respective priorities of the one or more other selected subchannels, the priority determining module 1008 refrains from transmitting the signal on the selected subchannel.

In an aspect, the apparatus 1002 may consider yielding to neighboring transmitters that are beyond a certain pathloss threshold when determining whether to transmit the signal on the selected subchannel. As described above, two transmitters located far away from each other may cause significant interference to each other due to in-band emissions. Therefore, the apparatus 1002 may decide to yield to another transmitter 1050 to avoid encountering interference when transmitting.

For example, after the priority determining module 1008 determines that the priority of the selected subchannel is the highest priority, or one of the top number of priorities, among the respective priorities of the one or more other selected subchannels, the pathloss detection module 1010 may further detect a pathloss of at least one neighboring transmitter (e.g., transmitter 1050). The pathloss detection module 1010 further determines whether the detected pathloss is below a threshold. When the detected pathloss of the at least one neighboring transmitter 1050 is above the threshold, the pathloss detection module 1010 refrains from transmitting the signal on the selected subchannel. When the detected pathloss of the at least one neighboring transmitter 1050 is below the threshold, the pathloss detection module 1010 transmits the signal on the selected subchannel.

The apparatus may include additional modules that perform each of the steps of the algorithm in the aforementioned flow chart of FIG. 9. As such, each step in the aforementioned flow chart of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

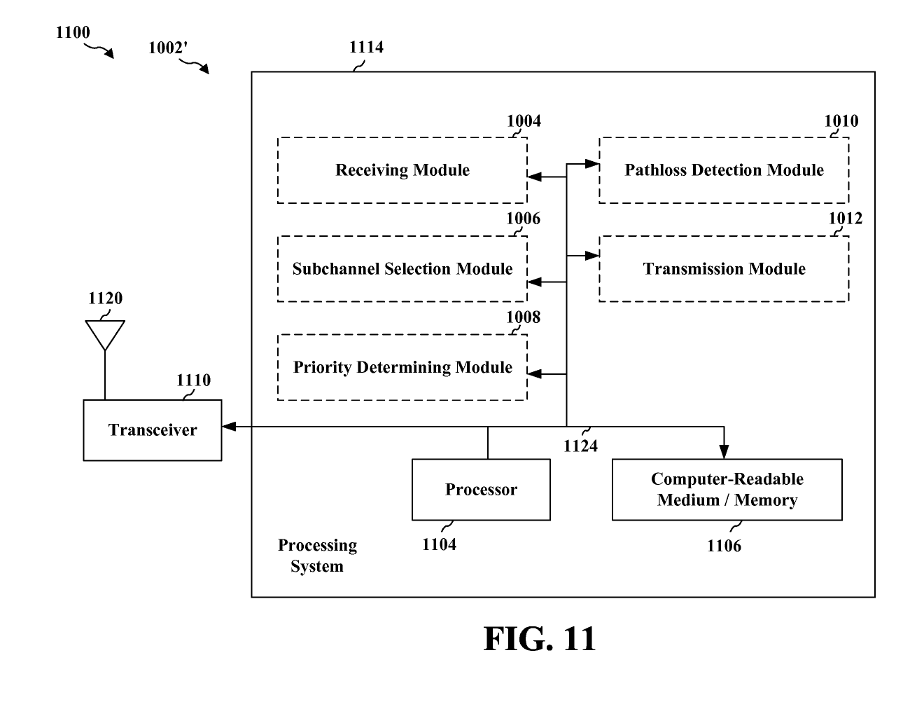

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010, 1012, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the receiving module 1004. In addition, the transceiver 1110 receives information from the processing system 1114, specifically the transmission module 1012, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system further includes at least one of the modules 1004, 1006, 1008, 1010, and 1012. The modules may be software modules running in the processor 1104, resident/stored in the computer readable medium/memory 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659.

In one configuration, the apparatus 1002/1002′ for wireless communication includes means for selecting a subchannel for transmitting a signal; means for determining a priority of the selected subchannel with respect to one or more other subchannels respectively selected by one or more neighboring transmitters; means for determining whether to transmit the signal on the selected subchannel based on the priority; means for transmitting the signal on the selected subchannel when the priority of the selected subchannel is a highest priority among respective priorities of the one or more other selected subchannels; means for transmitting the signal on the selected subchannel when the priority of the selected subchannel is one of a top number of priorities among respective priorities of the one or more other selected subchannels; means for detecting a pathloss of at least one neighboring transmitter, wherein the means for determining whether to transmit the signal on the selected subchannel is further configured to determine based on the detected pathloss; means for refraining from transmitting the signal on the selected subchannel when the detected pathloss of the at least one neighboring transmitter is above a threshold; means for transmitting the signal on the selected subchannel when: the priority of the selected subchannel is one of a top number of priorities among respective priorities of the one or more other selected subchannels, and the detected pathloss of the at least one neighboring transmitter is below a threshold.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
selecting a subchannel for transmitting a signal;
determining a priority of the selected subchannel with respect to one or more other subchannels respectively selected by one or more neighboring transmitters; and
determining whether to transmit the signal on the selected subchannel based on the priority.

2. The method of claim 1, further comprising:
transmitting the signal on the selected subchannel when the priority of the selected subchannel is a highest priority among respective priorities of the one or more other selected subchannels.

3. The method of claim 1, further comprising:
transmitting the signal on the selected subchannel when the priority of the selected subchannel is one of a top number of priorities among respective priorities of the one or more other selected subchannels.

4. The method of claim 1, further comprising:
detecting a pathloss of at least one neighboring transmitter,
wherein the determining whether to transmit the signal on the selected subchannel is further based on the detected pathloss.

5. The method of claim 4, further comprising:
refraining from transmitting the signal on the selected subchannel when the detected pathloss of the at least one neighboring transmitter is above a threshold.

6. The method of claim 4, further comprising:
transmitting the signal on the selected subchannel when:
the priority of the selected subchannel is one of a top number of priorities among respective priorities of the one or more other selected subchannels, and
the detected pathloss of the at least one neighboring transmitter is below a threshold.

7. The method of claim 1, wherein the determining the priority of the selected subchannel comprises:
performing a random permutation for the selected subchannel and the one or more other selected subchannels; and
defining an order of priority among the selected subchannel and the one or more other selected subchannels based on the random permutation.

8. An apparatus for wireless communication, comprising:
means for selecting a subchannel for transmitting a signal;
means for determining a priority of the selected subchannel with respect to one or more other subchannels respectively selected by one or more neighboring transmitters; and
means for determining whether to transmit the signal on the selected subchannel based on the priority.

9. The apparatus of claim 8, further comprising:
means for transmitting the signal on the selected subchannel when the priority of the selected subchannel is a highest priority among respective priorities of the one or more other selected subchannels.

10. The apparatus of claim 8, further comprising:
means for transmitting the signal on the selected subchannel when the priority of the selected subchannel is one of a top number of priorities among respective priorities of the one or more other selected subchannels.

11. The apparatus of claim 8, further comprising:
means for detecting a pathloss of at least one neighboring transmitter,
wherein the means for determining whether to transmit the signal on the selected subchannel is further configured to determine based on the detected pathloss.

12. The apparatus of claim 11, further comprising:
means for refraining from transmitting the signal on the selected subchannel when the detected pathloss of the at least one neighboring transmitter is above a threshold.

13. The apparatus of claim 11, further comprising:
means for transmitting the signal on the selected subchannel when:
the priority of the selected subchannel is one of a top number of priorities among respective priorities of the one or more other selected subchannels, and
the detected pathloss of the at least one neighboring transmitter is below a threshold.

14. The apparatus of claim 8, wherein the means for determining the priority of the selected subchannel is configured to:
perform a random permutation for the selected subchannel and the one or more other selected subchannels; and
define an order of priority among the selected subchannel and the one or more other selected subchannels based on the random permutation.

15. An apparatus for wireless communication, comprising:
a memory; and
at least one processor coupled to the memory and configured to:
select a subchannel for transmitting a signal;
determine a priority of the selected subchannel with respect to one or more other subchannels respectively selected by one or more neighboring transmitters; and
determine whether to transmit the signal on the selected subchannel based on the priority.

16. The apparatus of claim 15, the at least one processor further configured to:
transmit the signal on the selected subchannel when the priority of the selected subchannel is a highest priority among respective priorities of the one or more other selected subchannels.

17. The apparatus of claim 15, the at least one processor further configured to:
transmit the signal on the selected subchannel when the priority of the selected subchannel is one of a top number of priorities among respective priorities of the one or more other selected subchannels.

18. The apparatus of claim 15, the at least one processor further configured to:
detect a pathloss of at least one neighboring transmitter,
wherein the at least one processor configured to determine whether to transmit the signal on the selected subchannel is further configured to determine based on the detected pathloss.

19. The apparatus of claim 18, the at least one processor further configured to:
refrain from transmitting the signal on the selected subchannel when the detected pathloss of the at least one neighboring transmitter is above a threshold.

20. The apparatus of claim 18, the at least one processor further configured to:
transmit the signal on the selected subchannel when:
the priority of the selected subchannel is one of a top number of priorities among respective priorities of the one or more other selected subchannels, and
the detected pathloss of the at least one neighboring transmitter is below a threshold.

21. The apparatus of claim 15, wherein the at least one processor configured to determine the priority of the selected subchannel is configured to:
perform a random permutation for the selected subchannel and the one or more other selected subchannels; and
define an order of priority among the selected subchannel and the one or more other selected subchannels based on the random permutation.

22. A computer program product stored on a computer-readable medium and comprising code that when executed on at least one processor causes the at least one processor to:
select a subchannel for transmitting a signal;
determine a priority of the selected subchannel with respect to one or more other subchannels respectively selected by one or more neighboring transmitters; and
determine whether to transmit the signal on the selected subchannel based on the priority.

23. The computer program product of claim 22, further comprising code that causes the at least processor to:
transmit the signal on the selected subchannel when the priority of the selected subchannel is a highest priority among respective priorities of the one or more other selected subchannels.

24. The computer program product of claim 22, further comprising code that causes the at least processor to:
transmit the signal on the selected subchannel when the priority of the selected subchannel is one of a top number of priorities among respective priorities of the one or more other selected subchannels.

25. The computer program product of claim 22, further comprising code that causes the at least processor to:
detect a pathloss of at least one neighboring transmitter,
wherein the code that causes the at least one processor to determine whether to transmit the signal on the selected subchannel is further configured to determine based on the detected pathloss.

26. The computer program product of claim 25, further comprising code that causes the at least one processor to:
refrain from transmitting the signal on the selected subchannel when the detected pathloss of the at least one neighboring transmitter is above a threshold.

27. The computer program product of claim 25, further comprising code that causes the at least one processor to:
transmit the signal on the selected subchannel when:
the priority of the selected subchannel is one of a top number of priorities among respective priorities of the one or more other selected subchannels, and
the detected pathloss of the at least one neighboring transmitter is below a threshold.

28. The computer program product of claim 22, wherein the code that causes the at least one processor to determine the priority of the selected subchannel is configured to:
perform a random permutation for the selected subchannel and the one or more other selected subchannels; and
define an order of priority among the selected subchannel and the one or more other selected subchannels based on the random permutation.
